(19) United States
(12) Patent Application Publication
(10) Pub. No.: US 2026/0307978 A1
(43) Pub. Date: Oct. 8, 2026

(54) SYSTEM AND METHOD OF FUEL DISPENSER IMPACT CONVEYANCE

(71) Applicant: Gilbarco Inc., Greensboro, NC (US)

(72) Inventors: Edward A. Payne, Kernersville, NC (US); Donald Halla, Tucson, AZ (US)

(21) Appl. No.: 19/459,466

(22) Filed: Jan. 26, 2026

Related U.S. Application Data
(60) Provisional application No. 63/749,545, filed on Jan. 25, 2025.

(51) Int. Cl. B67D 7/32

(52) U.S. Cl. CPC B67D 7/3218; B67D 7/3281

(57) ABSTRACT

This invention provides a system for detecting and communicating impact events on fuel dispensers in hazardous environments, such as fueling stations. Impact sensors detect accelerative forces, and fiber-optic cables ensure reliable communication to remote systems, even if the dispenser is displaced. The system triggers automatic safety measures, including fuel pump shutdown and power disconnection, to prevent accidents like fuel leaks or fires. Temporary energy storage ensures continued operation and communication after power loss, offering a comprehensive safety solution for both hydraulic and electrical hazards.

### CROSS-REFERENCE TO A RELATED APPLICATION

This application is based upon and claims the benefit of provisional application Ser. No. 63/749545, filed Jan. 25, 2025, incorporated fully herein by reference for all purposes.

### FIELD

The present invention relates to fuel dispensers. More particularly, the present invention relates to impact detection and safety systems designed for use in retail fueling stations or other hazardous environments.

### BACKGROUND

Retail fuel dispensers are critical components in fueling stations, responsible for the controlled dispensing of fuel to customers' vehicles. Given their location on the forecourt, these dispensers are vulnerable to impacts from vehicles, falling debris, or severe weather conditions. Such impacts can lead to significant risks, including: severance of hydraulic lines, causing pressurized fuel to leak into the surrounding environment; exposure of electrical conductors, creating potential ignition sources; and displacement or total detachment of the dispenser from its mounting, leading to physical instability and further damage.

In hazardous environments where fuel vapors and liquids are present, these incidents pose a substantial risk of fire or explosion. Electrical sparks generated from exposed wiring, in combination with leaked fuel, can ignite the vapors, leading to significant consequences. To address these hazards, conventional systems rely on mechanical shutoff valves and physical barriers to contain fuel and prevent fire. These systems typically activate only after a significant event has already occurred, such as a leak or fire, but do not offer a method for early detection of potential hazards resulting from fuel dispenser detachment.

Presently, some fueling stations use mechanical systems to mitigate fuel flow in the event of a dispenser detachment. These systems are often activated by direct physical displacement of key mechanical components, such as shear valves or emergency shutoff devices. However, these systems lack the ability to convey detailed information about the impact, and they only address the hydraulic system. This means they do not prevent or mitigate the risks associated with exposed electrical wiring or provide detailed feedback to remote monitoring systems.

Other existing solutions incorporate basic electronic sensors to detect malfunctions. These systems may automatically shut off fuel flow if abnormal pressure is detected in the fuel lines. However, they fail to offer a comprehensive response in the event of a collision or displacement of the dispenser itself. Additionally, traditional electronic systems often rely on electrical connectivity, which can be severed during a collision, leading to a loss of communication and system failure.

Still other modern systems attempt to use wireless communication protocols, such as Wi-Fi, to detect and relay information about fuel dispenser malfunctions. While these systems eliminate the need for physical wiring, they face significant limitations related to signal interference, security vulnerabilities, line-of-sight limitations or store-and-forward architectural dependencies, and limited range in outdoor, high-interference environments like fueling stations.

Unfortunately, none of these systems of the prior art adequately address the need for a robust, reliable communication link in the event of an impact, particularly when the dispenser is displaced from its base, causing a severance of physical connections. Moreover, existing systems do not prioritize real-time communication to remote systems, which could initiate immediate safety responses.

### SUMMARY

To overcome existing problems and to provide a new and novel impact detection and safety system for use in a hazardous environment, there is provided a system and method to detect and convey the occurrence of an impact on a fuel dispenser. This ensures the safe and rapid communication of such events to prevent accidents involving fuel leaks, fire, and electrical malfunctions.

The presently described system and method provides a means for detecting impact events and ensuring continued communication, e.g., via fiber-optic technology, even if the fuel dispenser is displaced. This information can be used to enable critical safety systems, such as the shutdown of submersible turbine pumps (STPs) and the disconnection of electrical power, to be triggered automatically, thereby minimizing the risk of fire or explosion.

A particular benefit of the new and novel system described herein is the ability to reliably detect and communicate an impact event on a fuel dispenser in real-time, especially in situations where the dispenser is physically displaced or detached from its mounting base. This preferably includes limiting the danger possible where the severance of hydraulic and electrical connections during such an event can lead to fuel leaks, exposed wiring, and potential ignition sources, creating a high-risk situation.

A particular advantage of embodiments of the new system and method is the ability to detect impacts on fuel dispensers in hazardous environments with high accuracy.

A related advantage is the ability to convey the occurrence of impact events even if the dispenser is detached from its base, ensuring that critical systems are alerted in real-time.

Still another advantage is the ability to maintain data communication via fiber-optic cables, which are resistant to electromagnetic interference and severance, providing more reliable communication compared to traditional copper wiring.

A further advantage is that embodiments of the system enable rapid safety responses, such as the immediate deactivation of fuel pumps and electrical systems to prevent further hazards.

Another advantage is the reduced risk of fires or explosions by addressing both hydraulic and electrical hazards in one system.

Still another advantage of certain embodiments is the use of temporary energy storage devices, such as one or more capacitors, to ensure that the system remains operational even if the dispenser's main power supply is cut off during an impact.

The new and novel system and method described herein provides a system for detecting and conveying the occurrence of an impact on a fuel dispenser in hazardous environments, such as retail fueling stations. The system includes one or more impact sensors installed within the dispenser to detect accelerative forces and displacements resulting from a collision or other external force.

Fiber-optic cables are preferably utilized to provide a robust, interference-resistant communication link between the dispenser and a remote-control system, ensuring that data transmission remains intact even if the dispenser is physically displaced.

Temporary energy storage devices such as capacitors ensure that the system continues to operate briefly after an impact, allowing time for the transmission of critical data to the remote endpoint.

Remote control systems are also preferably included. These receive impact data and initiate immediate safety responses, such as shutting down submersible turbine pumps (STPs) or disconnecting electrical power to the forecourt.

The system is designed to function in environments where fuel vapors and other combustibles are present, providing a proactive solution to prevent accidents resulting from fuel dispenser detachment.

According to one aspect, the present invention provides a fuel dispenser comprising a housing and a flexible dispensing hose. A nozzle is attached to the dispensing hose. Piping internal to the housing conducts flow of fuel from a fuel source to the hose and the nozzle. An impact detection system is also provided, including a processor and at least one impact sensor in a fixed position, the impact sensor being operative to provide a signal indicative of an impact event affecting the fuel dispenser. A communication node is operative to send information regarding the impact event from the fuel dispenser.

According to an exemplary embodiment, the at least one impact sensor may comprise a plurality of impact sensors. In this case, the plurality of impact sensors may include at least two of a strain gauge, a motion sensor, an accelerometer, and a gyroscopic sensor. In the case of a strain gauge, planar forces in multiple (e.g., orthogonal) planes and/or shear forces may be detected.

According to an exemplary embodiment, the impact detection system further includes a fiber optic cable connected to the communication node. For example, the fuel dispenser may further include a vapor barrier separating an interior of the housing into an electronics compartment and a hydraulics compartment, the fiber optic cable passing through the vapor barrier. Additionally, the fiber optic cable may have an excess length portion located in the hydraulics compartment, the excess length portion being fed out in the event that the fuel dispenser is moved in the impact event. The excess length portion may, for example, be normally coiled or folded. In such embodiments, the communication node will generally comprise a fiber optic transceiver.

According to an exemplary embodiment, the impact detection system of the fuel dispenser further includes a temporary energy storage device providing sufficient energy to allow collection and sending of the information regarding the impact event even if power to the fuel dispenser is otherwise interrupted. For example, the temporary energy storage device may include at least one capacitor to maintain the temporary energy until needed for use.

A further aspect of the present invention provides an impact detection system for use with a dispenser of a flammable or toxic substance. The impact detection system according to this aspect comprises a processor and at least one impact sensor in a fixed position. The impact sensor is operative to provide a signal indicative of an impact event affecting the fuel dispenser. A communication node operative to send information regarding the impact event from the dispenser is also provided.

A still further aspect of the present invention provides a method of detecting and mitigating an impact event at a dispenser of a flammable or toxic substance. One step of the method involves providing an impact detection system at the dispenser, the impact detection system comprising a processor, at least one impact sensor operative to provide a signal indicative of an impact event affecting the dispenser, and a communication node. Another step involves interpreting, at the dispenser, a signal from the impact sensor to determine whether the impact event has occurred. A still further step involves sending information indicative of the impact event from the dispenser.

According to exemplary methodology, the interpreting step may involve determining if a severity of the impact event exceeds a threshold.

According to exemplary methodology, initiating one or more mitigation measures may be initiated in response to receipt of the information indicative of the impact event from the dispenser. For example, the one or more mitigation measures may involve at least one of cutting power to the dispenser and turning off a fuel pump.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

For a more complete understanding of the present disclosure and its advantages, reference is now made to the following description taken in conjunction with the accompanying drawings, in which like reference numbers represent like parts:

FIG. 1 is a diagrammatic representation of a fueling environment in which aspects of the present invention may be utilized.

FIG. 2 is a perspective view of an exemplary fuel dispenser utilized in the system of FIG. 1.

FIG. 3 is a diagrammatic representation showing certain internal components of the fuel dispenser of FIG. 2.

FIGS. 4A and 4B diagrammatically illustrate a fuel dispenser having impact detection capability according to the present invention before and after an impact event.

FIG. 5 diagrammatically illustrates components of an impact detection system according to an embodiment of the present invention.

FIG. 6 is a flow chart showing certain methodology in accordance with aspects of the present invention.

FIGS. 7A and 7B together show an exemplary circuit diagram that depicts impact sensors with accelerometers and gyroscopes mounted inside the fuel dispenser (designators U85 and U135) for detecting displacement or impact.

FIG. 8 is an exemplary schematic that illustrates a DC power sustain element (designator C7) used to store energy and provide temporary power for transmitting impact data after main power is lost.

FIGS. 9A, 9B, and 9C together show an exemplary schematic diagram that shows the fiber-optic data interface, which transmits impact detection data to the remote system.

FIG. 10 illustrates a typical armored fiber-optic cable with separate transmit and receive fibers, allowing secure data communication in hazardous environments.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

Aspects of the present invention provide comprehensive systems and methods for detecting impacts on a fuel dispenser and conveying information about such impacts to a remote system, even in situations where the dispenser is physically displaced from its mounting base. Preferred embodiments of the system use impact sensors, fiber-optic communication, and temporary energy storage devices to ensure continued functionality after an impact event.

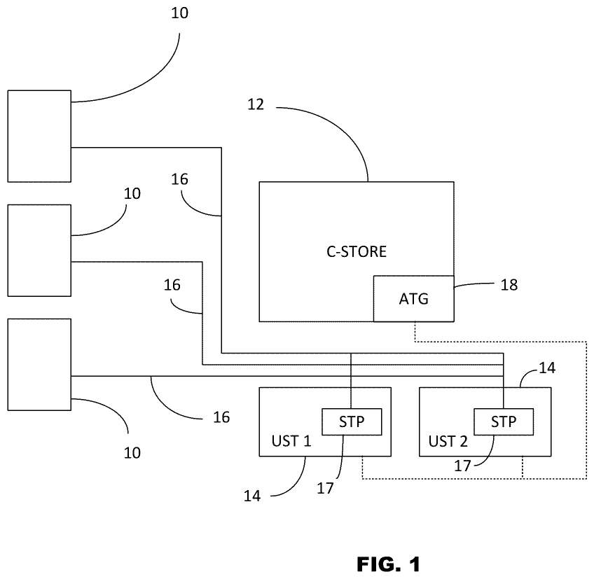

FIG. 1 illustrates an environment in which aspects of the present invention may be utilized. In this regard, a fueling site (e.g., service station) has a plurality of fuel dispensers 10. The fuel dispensers 10 are located in the forecourt area of the fueling site, and in electrical communication with a point-of-sale (POS) system located in a building such as a convenience store (“C-store”) 12. Typically, the fuel dispensers 10 will be provided with “pay-at-the-pump” capability, allowing the customer to authorize and pay for the fueling transaction at the dispenser itself. The POS system authorizes payment for the fuel to be dispensed, allows dispensing to begin, and may also typically handle in-store sales activities, as well as various inventory and configuration functions.

A plurality of fuel storage tanks, here underground storage tanks (USTs) 14, are also provided, each containing a respective grade or type of fuel (higher octane, lower octane, diesel, etc.). The USTs 14 supply the selected grade or type of fuel to the dispensers 10 through appropriate piping 16 (e.g., underground piping). A respective submersible turbine pump (STP) 17 is located in each of the USTs 14 to draw fuel from the tank to pressurize the piping 16. (In alternative embodiments, respective pumps may be located in the dispensers themselves to pull fuel from the USTs.) Each of the fuel dispensers 10 and USTs 14 are in electrical communication with an automatic tank gauge (ATG) 18, typically located in the C-store 12. The ATG 18, such as the TLS-450PLUS ATG sold by Veeder-Root Company, will typically utilize a combination of probe-based sensors and control consoles to monitor product levels, temperature, water presence, and tank conditions in real time.

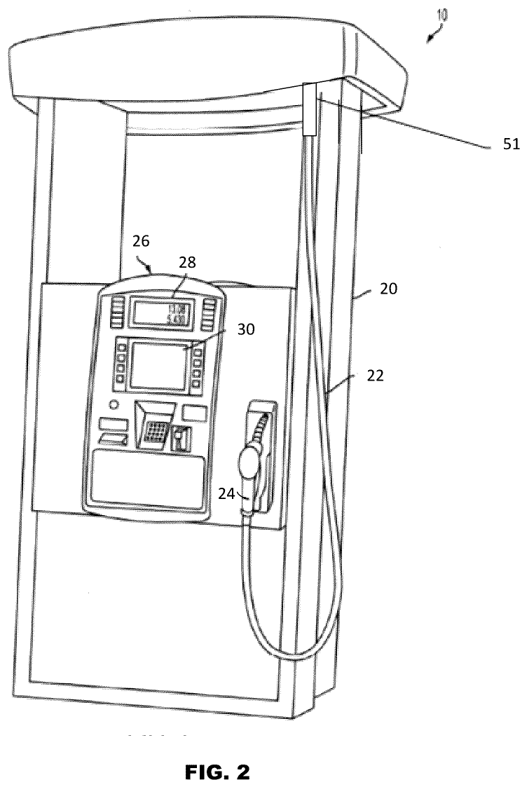

At this point, it is helpful to explain certain additional aspects of fuel dispensers 10. Referring now to FIG. 2, an exemplary fuel dispenser 10 according to an embodiment of the present invention is illustrated. Fuel dispenser 10 includes a housing 20 with a flexible fuel hose 22 extending therefrom. Fuel hose 22 terminates in a fuel nozzle 24 adapted to be inserted into a fill neck of a vehicle's fuel tank. Fuel nozzle 24 includes a manually operated fuel valve which the user typically opens by squeezing a lever. Various fuel handling components, such as valves and meters, are located inside of housing 20. These fuel handling components allow fuel to be received from a source (e.g., one or more USTs) and delivered through fuel hose 22 and fuel nozzle 24 to a vehicle's fuel tank.

Fuel dispenser 10 has a customer interface 26. Customer interface 26 may include an information display 28 relating to an ongoing fueling transaction that includes the amount of fuel dispensed and the price of the dispensed fuel. Further, customer interface 26 may include a display 30 that provides instructions to the customer regarding the fueling transaction. Display 30 may also provide advertising, merchandising, and multimedia presentations to a customer, and may allow the customer to purchase goods and services other than fuel at the dispenser.

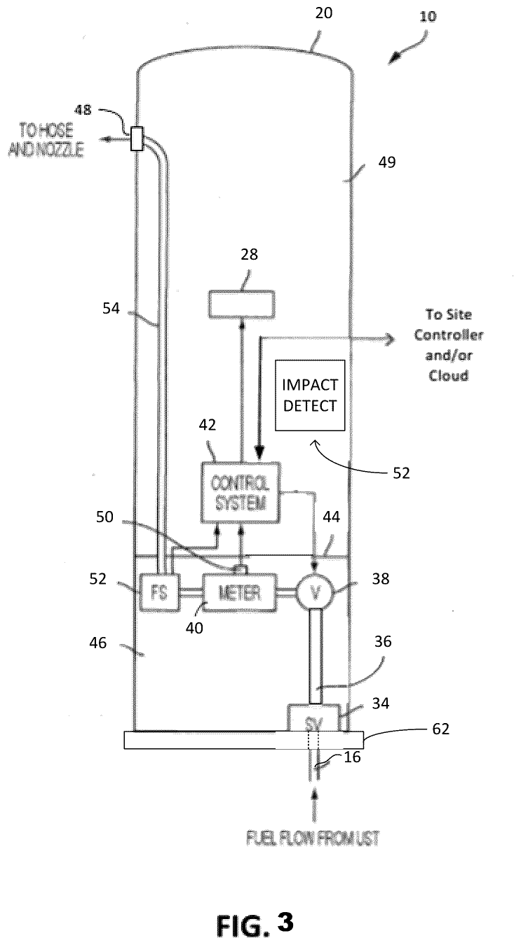

FIG. 3 is a schematic illustration of internal fuel flow components of fuel dispenser 10 according to an embodiment of the present invention. In general, fuel may travel from one or more USTs via main fuel piping 16, which may be a double-walled pipe having secondary containment as is well known, to fuel dispenser 10 and nozzle 24 for delivery. An exemplary underground fuel delivery system is illustrated in U.S. Pat. No. 6,435,204, hereby incorporated by reference in its entirety for all purposes.

Main fuel piping 16 typically passes into housing 20 through a shear valve 34. As is well known, shear valve 34 is designed to close the fuel flow path in the event of an impact to fuel dispenser 10. U.S. Pat. No. 8,291,928, hereby incorporated by reference in its entirety for all purposes, discloses an exemplary secondarily contained shear valve adapted for use in service station environments. Shear valve 34 contains an internal fuel flow path to carry fuel from main fuel piping 16 to internal fuel piping 36.

Fuel from the shear valve 34 flows toward a flow control valve 38 positioned upstream of a flow meter 40. Alternatively, valve 38 may be positioned downstream of the flow meter 40. In one embodiment, valve 38 may be a proportional solenoid-controlled valve, such as described in U.S. Pat. No. 5,954,080, hereby incorporated by reference in its entirety for all purposes.

Flow control valve 38 is under control of a control system 42. In this manner, control system 42 can control the opening and closing of flow control valve 38 to either allow fuel to flow or not flow through meter 40 and on to the hose 22 and nozzle 24. Control system 42 may comprise any suitable electronics with associated memory and software programs running thereon whether referred to as a processor, microprocessor, controller, microcontroller, or the like (the terms “processor,” “microprocessor,” etc. being considered equivalent in connection with the present document). In a preferred embodiment, control system 42 may be comparable to the microprocessor-based control systems used in CRIND (card reader in dispenser) type units sold by Gilbarco Veeder-Root (GVR). Control system 42 typically controls other aspects of fuel dispenser 10, such as valves, displays, and the like. For example, control system 42 typically includes a pump control board (or pump control node, “PCN”) which instructs flow control valve 38 to open when a fueling transaction is authorized. In addition, control system 42 may be in electronic communication with the POS (which many be or include a site controller) located at the fueling site. The site controller communicates with control system 42 to control authorization of fueling transactions and other conventional activities. The control system 42 may also be in communication with one or more host servers in the “cloud,” either directly or via the site controller, as necessary or desired.

A vapor barrier 44 delimits hydraulics compartment 46 of fuel dispenser 10, and control system 42 is located in electronics compartment 49 above vapor barrier 44. Fluid handling components, such as valve 38 and flow meter 40, are located in hydraulics compartment 46. In this regard, flow meter 40 may be any suitable flow meter known to those of skill in the art, including positive displacement, inferential, and Coriolis mass flow meters, among others. Meter 40 typically comprises electronics 50 that communicate information representative of the flow rate or volume to control system 42. For example, electronics 50 may typically include a pulser as known to those skilled in the art. In this manner, control system 42 can update the total gallons (or liters) dispensed and the price of the fuel dispensed on information display 28.

As fuel leaves flow meter 40 it may enter a flow switch 52, which preferably comprises a one-way check valve that prevents rearward flow through fuel dispenser 10. Flow switch 52 provides a flow switch communication signal to control system 42 when fuel is flowing through flow meter 40. The flow switch communication signal indicates to control system 42 that fuel is actually flowing in the fuel delivery path and that subsequent signals from flow meter 40 are due to actual fuel flow. Fuel from flow switch 52 exits through internal fuel piping 54 to fuel hose 22 and nozzle 24 for delivery to the customer's vehicle. An example flow switch which may be utilized with embodiments of the present invention is shown and described in U.S. Pat. No. 6,763,974, incorporated fully herein by reference for all purposes.

A blend manifold 48 may also be provided downstream of flow switch 52. The blend manifold receives fuels of varying octane levels from the various USTs and ensures that fuel of the octane level selected by the customer is delivered. A breakaway valve 51 (FIG. 2) may be located at the proximal end of hose 22. If a customer attempts to drive away with the nozzle in the vehicle's fill neck, the hose 22 will separate from the dispenser and valve 51 will close to contain fuel that would otherwise spill. In addition, fuel dispenser 10 may comprise a vapor recovery system to recover fuel vapors through nozzle 24 and hose 22 for return to the UST. An example of a vapor recovery assist equipped fuel dispenser is disclosed in U.S. Pat. No. 5,040,577, incorporated by reference herein in its entirety for all purposes.

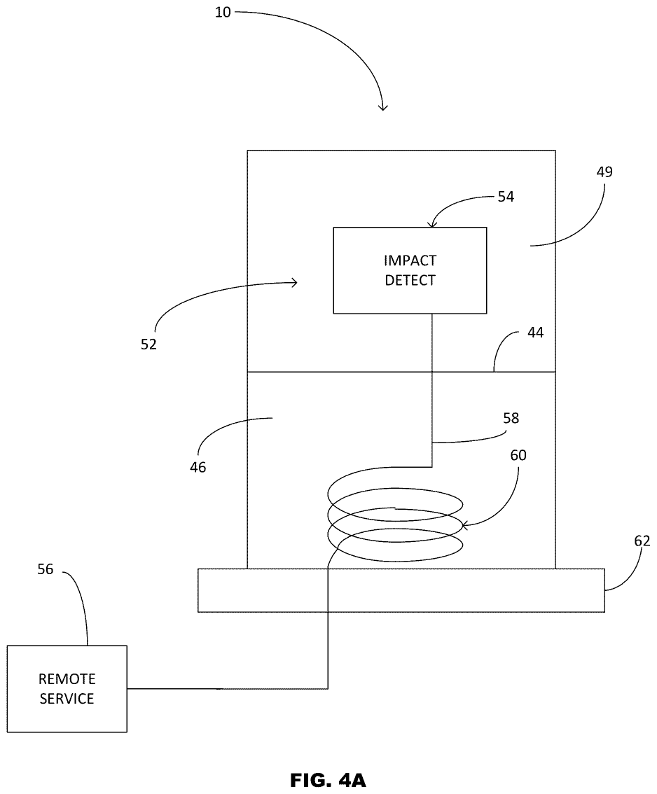

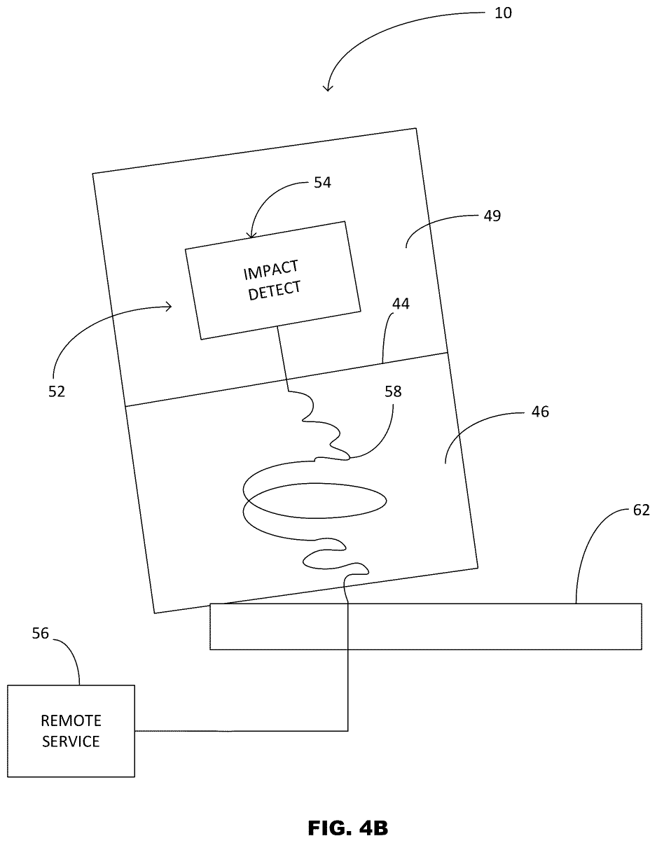

Dispenser 10 further has an impact detection system (generally 52) in accordance with the present invention. Referring now also to FIGS. 4A and 4B, the various electrical components (generally 54) of impact detection system 52 are typically located above the vapor barrier 44 of dispenser 10 (i.e., in the electronics compartment 49). As will be described more fully, below, these components 54 include one or more impact sensors that indicate impact to or movement of the fuel dispenser 10. Various types of sensors may be used for this purpose, including accelerometers, gyroscopic sensors, strain or shear gauges, etc. If impact or movement exceeding a predetermined threshold is detected, a signal may be sent to a remote service 56 to initiate mitigation actions. Such mitigation actions may include, for example, shut off of electrical power to the dispenser, shut down of the STPs, or other steps necessary to reduce risk associated with the impact. The remote service 56 may be located in the C-store 12 or remote from the C-store 12, as necessary or desired. For example, the functionality of remote service 56 may often be incorporated into the site controller at the C-store 12.

Signal communication between components 54 and remote service 56 may be achieved in any suitable manner but will typically be accomplished utilizing a fiber optic (FO) cable 58. As shown, FO cable 58 passes through vapor barrier 44 into the hydraulics compartment 46 of dispenser 10, such as via gland seal (ATEX), potted feed-through bushing (UL), or other mechanical methods to secure the FO cable 58 and facilitate its transition through barrier 44. Because FO cable 58 passes optical signals rather than electrical signals, safety concerns that may arise through the use of electrical wiring in the hydraulics compartment are obviated. Preferably, the portion of the FO cable 58 in the hydraulics compartment 46 will have an extra length portion of sufficient length so that it does not sever (or does not sever too quickly) if the dispenser moves by impact. For example, as shown, the extra length portion may be coiled (as indicated at 60) or folded so that it will feed out as the dispenser 10 moves.

This is illustrated in FIG. 4B, where it can be seen that dispenser 10 has been moved by impact from its normal position on base (pedestal) 62. FO cable 58 has somewhat uncoiled to compensate for the movement of dispenser 10. Components 54 detect the impact and inform remote service 56 via an internal communication node (e.g., optical fiber transceiver) so that mitigating actions can be taken.

Referring now to FIG. 5, components 54 may be further explained. As shown, one or more impact sensors 64 are mounted at appropriate locations in or on the fuel dispenser housing. Preferably, a plurality of such impact sensors are provided. For example, it may be desirable to use impact sensors of different types to measure different force components, such as shear, planar strain in multiple orthogonal planes, movement, etc. Signals from the impact sensors 64 are fed to a suitable processor 66, which may calculate the direction and extent that the fuel dispenser has moved. Any impacts exceeding a threshold, e.g., greater than a minimal bump or vibration expected during normal use, may be reported to the remote service 56. Toward this end, a fiber optic transceiver 68 is provided in this embodiment to convert signals from and to optical format. (Note that embodiments are contemplated in which two-way communication occurs between processor 66 and remote service 56. For example, remote service 56 may initiate periodic diagnostics to confirm that impact detection system 52 is operating properly.) An energy storage device 70 is provided to continue powering components 54 for a sufficient time after impact so that processor 66 can complete reporting even if mains power is lost. For example, one or more suitable capacitors may be utilized for this purpose.

In alternative embodiments, processor 66 may not determine if the impact threshold has been achieved. Instead, impact signals from the sensors 64 are packaged and possibly pre-processed at processor 66, which passes them to remote service 56 for more intensive calculations.

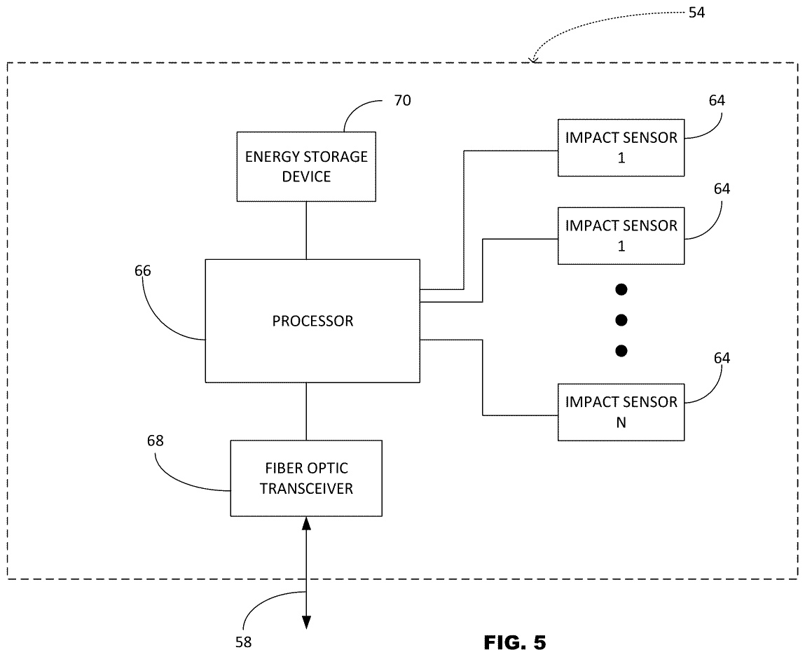

Certain methodology according to the present invention may be most easily explained with reference to FIG. 6. The process starts at 100. At 102, a determination is made whether an impact has occurred. If not, the system waits. If so, a determination is made at 104 as to whether a threshold (e.g., force or displacement) has been met. If so, impact data is sent to remote service 56 (at 106). At step 108, remote service 56 can then initiate mitigation actions as described above.

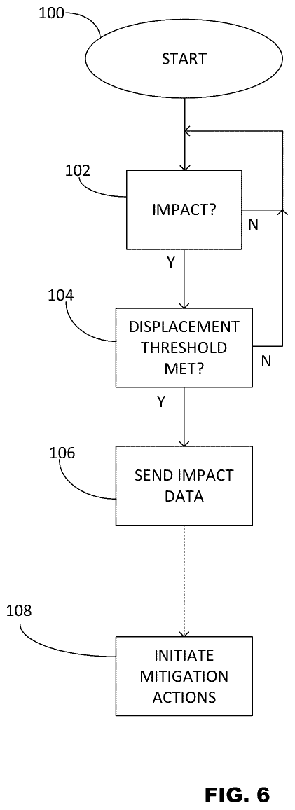

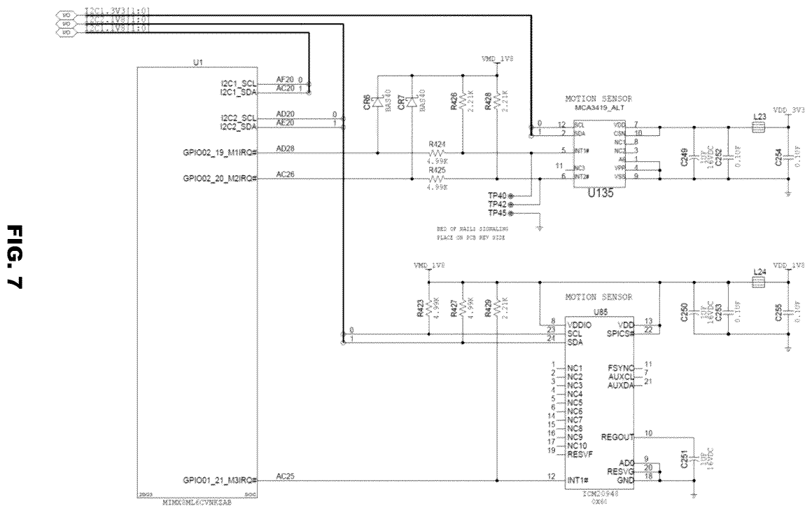

FIGS. 7A-10 show aspects of the present invention according to a specific embodiment. Turning now to FIGS. 7A-7B, there are two motion or impact sensors, designators U85 and U135, mounted in such a manner as to have accelerative and/or displacive forces impinged upon the dispenser's frame mechanically communicated thereto. Note that although two sensors are shown, at least one sensor is sufficient for the purposes of the embodiment described herein. In addition, there are no limitations as to the number of sensors that may be used. It is also to be noted that sensor U85 contains both accelerometric and gyroscopic elements. However, for the purposes of the invention described herein, either, or for that matter, any suitable motion-sensing technology will suffice.

Sensors U85 and U139 are in communication with the local host CPU, designator U1. Sensors U85 and U135 provide at least one Cartesian axis of motion measurement. In an exemplary embodiment, axes x, y, and z are included. Similarly, there is nothing to prohibit polar coordinates, partial or full, or conversion from or to these coordinates.

If more than one axis measurement is available, the vector sum (square root of the quantity x, y, and if available, z, all squared) is desired to sense dispenser acceleration and/or displacement from non-orthogonal impacts. Whereas vector summation is described herein, other algorithms may be used as well without departing from the scope of this embodiment.

Referring now to FIG. 8, there is shown a capacitor, designator C7, for energy storage purposes in that, upon loss of dispenser electrical power input, sufficient energy resides therein to power the local host CPU U1 for a time sufficient to transmit a message conveying that a dispenser impact has occurred. Although capacitor C7 is shown by way of example, alternate energy storage devices may be used.

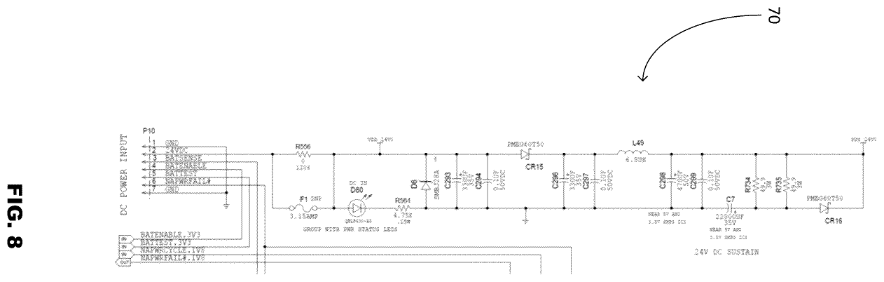

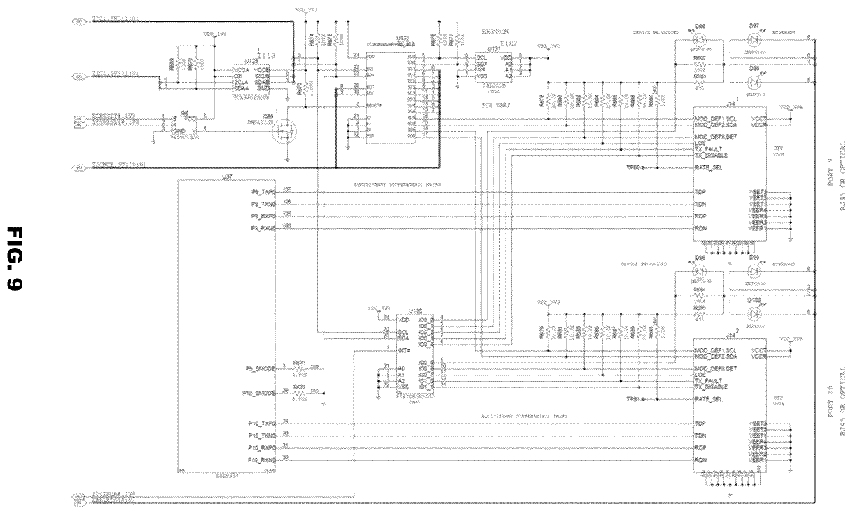

Referring to FIGS. 9A-9C, there is a fiberoptic data interface in direct or indirect communication with the local host CPU U1. In operation, by software or other algorithm, upon concluding that a threshold of motion has been satisfied or exceeded, a message or packet is transmitted by attached fiberoptic cable to be received and acted upon by a separate endpoint device (e.g., remote service 56) in communication with the fiberoptic cable.

Responses to the message or packet may include, but are not limited to, depressurization of fuel by de-energization of submersible or above-ground turbine pumps (generally, STPs), and/or the de-energization of electrical apparatuses, including but not limited to fuel dispensers.

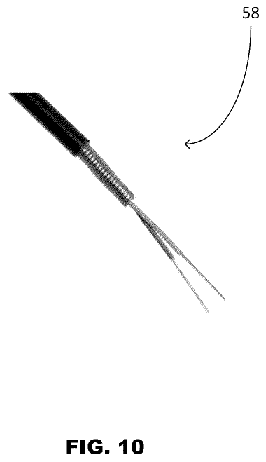

FIG. 10 depicts a common jacketed fiberoptic cable 58 suitable for excess length and storage within the dispenser's hydraulic cabinet. Additionally, it is suitable for operation within an area subject to flammable or explosive vapors being present, or flammable or explosive fuel being present. Note that excess length is considered as exceeding the maximum anticipated physical translation expected as a result of an impact resulting in the full mechanical detachment of the fuel dispenser. The excess length will differ depending on the design of the dispenser.

Note that fiberoptic cable 58 may be placed within the hydraulic area of a fuel dispenser. It may be stored in a coiled state or any other desired manner. This ensures excess cable length to maintain communication if the dispenser is displaced.

Many modifications and other embodiments of devices and/or methodology set forth herein will come to mind to one skilled in the art to which they pertain having the benefit of the teachings presented in the foregoing descriptions and the associated drawings. For example, embodiments are contemplated using various wired and wireless technologies in lieu of or in addition to a FO cable to provide impact information to the remote service. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A fuel dispenser comprising:
a housing;
a flexible dispensing hose;
a nozzle attached to the dispensing hose;
piping internal to the housing to conduct flow of fuel from a fuel source to the hose and the nozzle; and
an impact detection system including:
a processor;
at least one impact sensor in a fixed position, the impact sensor operative to provide a signal indicative of an impact event affecting the fuel dispenser; and
a communication node operative to send information regarding the impact event from the fuel dispenser.

2. A fuel dispenser as set forth in claim 1, wherein the at least one impact sensor comprises a plurality of impact sensors.

3. A fuel dispenser as set forth in claim 2, wherein the plurality of impact sensors includes at least two of a strain gauge, a motion sensor, an accelerometer, and a gyroscopic sensor.

4. A fuel dispenser as set forth in claim 1, the impact detection system further includes a fiber optic cable connected to the communication node.

5. A fuel dispenser as set forth in claim 4, wherein the fuel dispenser further includes a vapor barrier separating an interior of the housing into an electronics compartment and a hydraulics compartment, the fiber optic cable passing through the vapor barrier.

6. A fuel dispenser as set forth in claim 5, wherein the fiber optic cable has an excess length portion located in the hydraulics compartment, the excess length portion being fed out in the event that the fuel dispenser is moved in the impact event.

7. A fuel dispenser as set forth in claim 6, wherein the excess length portion is normally coiled or folded.

8. A fuel dispenser as set forth in claim 1, wherein the communication node comprises a fiber optic transceiver.

9. A fuel dispenser as set forth in claim 1, wherein the impact detection system further includes a temporary energy storage device providing sufficient energy to allow collection and sending of the information regarding the impact event even if power to the fuel dispenser is otherwise interrupted.

10. A fuel dispenser as set forth in claim 9, wherein the temporary energy storage device includes at least one capacitor to maintain the temporary energy until needed for use.

11. An impact detection system for use with a dispenser of a flammable or toxic substance, the impact detection system comprising:
a processor;
at least one impact sensor in a fixed position, the impact sensor operative to provide a signal indicative of an impact event affecting the fuel dispenser; and
a communication node operative to send information regarding the impact event from the dispenser.

12. An impact detection system as set forth in claim 11, wherein the at least one impact sensor comprises a plurality of impact sensors.

13. An impact detection system as set forth in claim 12, wherein the plurality of impact sensors includes at least two of a strain gauge, a motion sensor, an accelerometer, and a gyroscopic sensor.

14. An impact detection system as set forth in claim 11, further comprising a fiber optic cable extending connected to the communication node.

15. An impact detection system as set forth in claim 14, wherein the fiber optic cable has an excess length portion configured to be fed out in the event that the dispenser is moved in the impact event.

16. An impact detection system as set forth in claim 15, wherein the excess length portion is coiled or folded.

17. An impact detection system as set forth in claim 14, wherein the fiber optic cable comprises an armored fiber optic cable.

18. An impact detection system as set forth in claim 11, wherein the communication node comprises a fiber optic transceiver.

19. An impact detection system as set forth in claim 11, wherein the impact detection system further includes a temporary energy storage device providing sufficient energy to allow collection and sending of the information regarding the impact event even if power to the fuel dispenser is otherwise interrupted.

20. An impact detection system as set forth in claim 19, wherein the temporary energy storage device includes at least one capacitor to maintain the temporary energy until needed for use.

21. A method of detecting and mitigating an impact event at a dispenser of a flammable or toxic substance, the method comprising steps of:
providing an impact detection system at the dispenser, the impact detection system comprising a processor, at least one impact sensor operative to provide a signal indicative of an impact event affecting the dispenser, and a communication node;
interpreting, at the dispenser, a signal from the impact sensor to determine whether the impact event has occurred; and
sending information indicative of the impact event from the dispenser.

22. A method as set forth in claim 21, wherein the interpreting step involves determining if a severity of the impact event exceeds a threshold.

23. A method as set forth in claim 21, further comprising the step of initiating one or more mitigation measures in response to receipt of the information indicative of the impact event from the dispenser.

24. A method as set forth in claim 23, wherein the one or more mitigation measures involves at least one of cutting power to the dispenser and turning off a fuel pump.
